(19) United States
(12) Patent Application Publication
(10) Pub. No.: US 2025/0360467 A1
(43) Pub. Date: Nov. 27, 2025

(54) Systems and methods employing metal foil pumps for direct internal recycling of fusion reactor exhaust plasma

(71) Applicant: Colorado School of Mines, Golden, CO (US)

(72) Inventors: Colin Wolden, Golden, CO (US); Chao Li, Golden, CO (US); Doug Way, Golden, CO (US)

(21) Appl. No.: 19/214,780

(22) Filed: May 21, 2025

Related U.S. Application Data
(60) Provisional application No. 63/650,204, filed on May 21, 2024.

(51) Int. Cl. B01D 71/02; B01D 53/22; B01D 53/32; G21B 1/11

(52) U.S. Cl. CPC B01D 71/02231; B01D 53/228; B01D 53/326; G21B 1/11; B01D 2053/221; B01D 2257/108; B01D 2258/02

(57) ABSTRACT

The present disclosure provides systems and methods for the processing of exhaust gas of a fusion reactor by direct internal recycling using metal foil pumps. One aspect of the disclosure is a system for the continuous or semi-continuous processing of plasma exhaust of a fusion reactor, comprising one or more metal foil pumps, the one or more metal foil pumps configured to operate at a temperature withing a range of approximately 25° C. to approximately 200° C. Another aspect is a system for direct internal recycling of deuterium and tritium, comprising: a feed region, a permeate region, and one or more metal foil pumps, configured to selectively allow hydrogen isotopes in the plasma exhaust to permeate therethrough into the permeate region, and to selectively absorb or repel helium in the plasma exhaust The one or more metal foil pumps may comprise a material selected from the group consisting of palladium, a palladium-copper alloy, a palladium-silver alloy, iron, and combinations thereof.

### RELATED APPLICATIONS

This application claims the benefit of Provisional Application No. 63/650,204, filed on May 21, 2024. This application is incorporated herein by reference in its entirety for all purposes.

### STATEMENT REGARDING FEDERALLY SPONSORED RESEARCH

This invention was made with government support under grant number DE-AR0001368 awarded by Advanced Research Projects-Energy (ARPA-E) of the United States Department of Energy. The government has certain rights in the invention.

### FIELD

This disclosure relates generally to a method for the processing of exhaust gas of a fusion reactor by direct internal recycling using metal foil pumps.

### BACKGROUND

Controlled nuclear fusion has seen significant progress in recent years. Significant breakthroughs in energy output and plasma physics bring humanity closer to the commercialization of fusion power generation. However, various enabling technical and engineering challenges must be addressed to ensure the safe and sustainable operation of fusion power plants, including effective fuel management. The leading concepts rely on fusion of the hydrogen (H) isotopes deuterium and tritium (DT) to form helium (He) and an energetic neutron. While deuterium (D) is relatively abundant, the radioactive nature and short half-life of tritium (T) requires that it be generated and recycled on-site. In fusion plasma, only a fraction (˜1%) of the injected deuterium (D) and tritium (T) undergo conversion to helium, necessitating efficient purification and recovery of unreacted DT from plasma exhaust. Currently, the extraction of hydrogen isotopes from helium relies on a separate tritium plant that mandates the presence of a large tritium inventory on site, which is not cost-effective and presents safety hazards. This fuel handling and the required tritium plant is expected to be one of the largest contributors to the capital cost of a fusion reactor.

Direct internal recycling (DIR) is the extraction of unreacted DT from the helium ash near the exhaust of the reaction chamber, or torus, and return of the purified isotopes back into the fueling system, bypassing the tritium plant. DIR offers multiple benefits, including reductions to the cost of the tritium plant, processing time, the tritium startup inventory, and the required tritium breeding ratio. In general, these savings scale linearly with the fraction of exhaust processed through DIR. However, processes in the tritium plant, such as the isotope separation system, require a certain minimum tritium level to work properly. Based on these tradeoffs, it has been estimated that the ideal DIR fraction is about 80%.

The leading technology for conducting DT purification in the DIR loop is the metal foil pump (MFP), a metallic membrane that selectively allows deuterium and tritium to permeate while repelling helium and other impurities, such as hydrocarbons, ammonia, hydrogen gas (H₂), and/or nitrogen. Unlike conventional pressure-driven hydrogen permeation, which adheres to a solution-diffusion mechanism, MFP operates through superpermeation. In this process, superthermal hydrogen radicals and ions directly absorb into the metal, bypassing the adsorption/dissociation process, leading to a substantial increase in solubility. These absorbed hydrogen atoms then rapidly diffuse and desorb downstream. This generally leads to a substantial increase in solubility relative to Sievert's law expectations.

To date, investigations into hydrogen superpermeation have predominantly utilized pure hydrogen gas (H₂) or the presence of trace level impurities, such as plasma-enhancement gases (e.g., argon), or the impact of contaminants (e.g., oxygen and carbon) on hydrogen-metal surface interaction physics. However, in the context of designing practical continuous DIR systems with the objective of attaining 80% isotope recovery, it becomes imperative to scrutinize the impact of elevated helium concentration during the permeation process. Aside from knowing, as it relates to the art in general, that superpermeation predominantly derives from hydrogen radicals and that there is a strong temperature dependence, such that attenuation drops at higher temperatures, there still remains a scarcity of knowledge in understanding helium's impact on hydrogen plasma permeation, especially at higher helium levels. While high helium levels are typically not experienced in DIR, it is known that there will be spatial variations within the system as DT isotopes are extracted, such that helium will be enriched at the surface of the metal foil due to concentration polarization.

Current DIR strategies rely on MFPs comprised of metals with body-centered cubic (BCC) crystal systems, such as vanadium, niobium, and/or tantalum, operated at high temperature (T>400° C.) and often employing a bias to accelerate ions to the foil. Part of the reason for high temperature is that the BCC metals are susceptible to hydrogen embrittlement at lower temperature. The plasma exhaust is expected to contain only about 1% helium, but during DIR the gas would be enriched in helium (in the limiting case, up to about 100% He) as hydrogen isotopes are extracted. As the plasma is enriched in helium, low energy (10-100 eV) helium ions can implant in the MFP, which rapidly attenuates MFP performance.

There is thus a need in the art for operation of MFPs at low temperature and/or with a bias that repels ions. It is advantageous for systems and methods of such MFP operation to be capable of very high recovery of hydrogen isotopes. Recognizing both the need for continuous processing and periodic regeneration of MFPs due to contamination from helium and other impurities in the plasma exhaust, it is still further advantageous for such systems and methods to make use of a bank of MFPs which alternate between use and regeneration to provide stable, continuous processing of the plasma exhaust.

### SUMMARY

In an aspect of the present disclosure, a system for the continuous processing of plasma exhaust of a fusion reactor comprises one or more metal foil pumps (“MFPs”), wherein the one or more metal foil pumps (MFPs) are configured to operate within a temperature range of approximately 25° C. to approximately 200° C.

In embodiments, the one or more MFPs may comprise a material selected from the group consisting of palladium (Pd), a palladium-copper (PdCu) alloy, a palladium-silver (PdAg) alloy, iron (Fe), and combinations thereof. The one or more MFPs may, but need not, comprise an approximately 60 wt % palladium/40 wt % copper alloy. The one or more MFPs may, but need not, comprise an approximately 75 wt % palladium/25 wt % silver alloy.

In embodiments, the one or more MFPs may be configured to achieve a direct internal recycling (“DIR”) fraction of at least about 60%. The one or more MFPs may, but need not, be configured to achieve a DIR fraction of at least about 80%. The one or more metal foil pumps may, but need not, be configured to achieve a DIR fraction of about 100%.

In embodiments, the temperature may be about 75° C.

In embodiments, the temperature may range from approximately 25° C. to approximately 200° C.

In embodiments, the temperature may be about 200° C.

In another aspect of the present disclosure, a system for DIR of DT comprises a feed region, in fluid communication with an outlet of a torus of a fusion reactor and configured to receive plasma exhaust from the torus; a permeate region, in fluid communication with an inlet of a fueling system of the fusion reactor and configured to discharge treated plasma exhaust into the fueling system; and one or more MFPs, configured to selectively allow hydrogen isotopes in the plasma exhaust in the feed region to permeate therethrough into the permeate region, and to selectively absorb or repel helium in the plasma exhaust such that the helium is retained in the feed region, thereby forming the treated plasma exhaust in the permeate region, at an operating temperature of about 25° C. to about 200° C.

In embodiments, the one or more MFPs may comprise a material selected from the group consisting of palladium (Pd), a palladium-copper (PdCu) alloy, a palladium-silver (PdAg) alloy, iron (Fe), and combinations thereof. The one or more MFPs may, but need not, comprise an approximately 60 wt % palladium/40 wt % copper alloy. The one or more MFPs may, but need not, comprise an approximately 75 wt % palladium/25 wt % silver alloy.

In embodiments, the one or more MFPs may be configured to achieve a DIR fraction of at least about 60%. The one or more MFPs may, but need not, be configured to achieve a DIR fraction of at least about 80%. The one or more MFPs may, but need not, be configured to achieve a DIR fraction of about 100%.

In embodiments, the operating temperature may be about 75° C.

In embodiments, the temperature may range from approximately 75° C. to approximately 200° C.

In embodiments, the temperature may be about 200° C.

In another aspect of the present disclosure, a method for direct internal recycling (“DIR”) of deuterium (D) and tritium (T) in a fusion power plant comprises introducing plasma exhaust from a torus of a fusion reactor into a feed region of a DIR system, the plasma exhaust comprising helium and D and/or T; causing the plasma exhaust in the feed region of the DIR system to contact one or more metal foil pumps (MFPs) of the DIR system, whereby the MFPs (i) selectively allow at least a portion of the D and/or T in the plasma exhaust in the feed region to permeate therethrough into a permeate region of the DIR system, thereby forming a treated plasma exhaust in the permeate region, and (ii) selectively absorb or repel at least a portion of the helium in the plasma exhaust in the feed region; and discharging the treated plasma exhaust from the permeate region of the DIR system into a fueling system of the fusion power plant, wherein an operating temperature in the DIR system ranges from about 25° C. to about 200° C. In embodiments, the one or more MFPs may comprise a material selected from the group consisting of palladium (Pd), a palladium-copper (PdCu) alloy, a palladium-silver (PdAg) alloy, iron (Fe), and combinations thereof. The one or more MFPs may, but need not, comprise an approximately 60 wt % palladium/40 wt % copper alloy. The one or more MFPs may, but need not, comprise an approximately 75 wt % palladium/25 wt % silver alloy.

In embodiments, the method may be characterized by a DIR fraction of at least about 60%. In other embodiments, the DIR fraction may, but need not, be at least about 80%. In still other embodiments, the DIR fraction may be about 100%.

In embodiments, the operating temperature may be about 75° C.

In embodiments, the temperature may range from approximately 75° C. to approximately 200° C.

In embodiments, the temperature may be about 200° C.

In embodiments of the present disclosure, T may be extracted from at least one breeder blanket disposed proximally to the torus.

In embodiments contemplated by the present disclosure, background permeation flux (being predominantly pressure-driven and being dependent on process history and length of time to evacuate the permeate chamber) may first occur. This may then be followed by plasma ignition, inducing a step function in flux that may then be allowed to stabilize thereby indicating establishment of a stable hydrogen plasma-drive permeation. This hydrogen plasma permeation may continue for a predetermined amount of time before being extinguished at a point where the flux drops precipitously. Once extinguished, the MFCs may be altered to deliver a different mixture of hydrogen to helium (such as 20% to 80%, or 60% 40%) to the chamber, then the process may be restarted wherein the plasma is reignited and operation continues until flux reaches a steady state (or at least exhibits a very gradual decline). It is contemplated that these steps may continue until the hydrogen fraction reaches 100% after beginning at 0% (or until the helium fraction reaches 0% after starting at 100%). It is further contemplated that these steps, and overall testing parameters, may be utilized for tests conducted at various temperatures and on various foils.

Generally, as it relates to some embodiments of the present disclosure contemplated herein, the plasma permeation was found to be highly stable until the helium factor reached approximately 80% (which is likely where the helium density becomes significant), at which point the flux did not reach a steady state but was slowly declining as the gas composition changed. Unlike in previous studies, the hydrogen concentration was found, at least in some embodiments herein, to be a function of the incident H flux, temperature, and state of the material surface wherein the presence of impurities was not found to be beneficial, particularly under low-temperature operations with Pd or alloys thereof. The ability of the Pd-based foils to deliver high flux at low temperatures and the reduced susceptibility to helium absorption are some of the most important attributes of at least some embodiments of the present disclosure.

In some embodiments, a modest negative bias may be beneficial, in order to mitigate the helium implantation, prevent helium absorption, reduce the energy of impinging helium below a threshold level without affecting the bulk plasma, and/or inhibit the flux, which has been attributed to sputter removal of surface impurities under high-temperature operations. In some embodiments, the bias applied to the metal foils is about −5 V to about −50 V, or any value in any subrange thereof.

While specific embodiments and applications have been illustrated and described, the present disclosure is not limited to the precise configuration and components described herein. Various modifications, changes, and variations which will be apparent to those skilled in the art may be made in the arrangement, operation, and details of the methods and systems disclosed herein without departing from the spirit and scope of the overall disclosure.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about.”

The use of “substantially” in the present disclosure, when referring to a measurable quantity (e.g., a width or other distance) and used for purposes of comparison, is intended to mean within 5% of the comparative quantity. The terms “substantially similar to,” “substantially the same as,” and “substantially equal to,” as used herein, should be interpreted as if explicitly reciting and encompassing the special case in which the items of comparison are “similar to,” “the same as” and “equal to,” respectively. The term “parallel” means two objects are oriented at an angle within plus or minus 0° to 5° unless otherwise indicated. Similarly, the term “perpendicular” means two objects are oriented at angle of from 85° to 95° unless otherwise indicated.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

As used herein, unless otherwise specified, all compositional percentages are expressed on a volume or molar basis, which, in the context of the inventive aspects described herein, can generally be considered equivalent or nearly equivalent to each other. By way of non-limiting example, a statement herein that a gas mixture contains “about 1% to about 5% helium” means that helium makes up about 1% to about 5% of the gas mixture on a volume basis, or on a molar basis, or both.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. The use of “engaged with” and variations thereof herein is meant to encompass any direct or indirect connections between components.

It shall be understood that the term “means” as used herein shall be given its broadest possible interpretation in accordance with 35 U.S.C. § 112 (f). Accordingly, a claim incorporating the term “means” shall cover all structures, materials, or acts set forth herein, and all of the equivalents thereof. Further, the structures, materials, or acts and the equivalents thereof shall include all those described in the summary, brief description of the drawings, detailed description, abstract, and claims themselves.

All external references are hereby incorporated by reference in their entirety whether explicitly stated or not.

These and other advantages will be apparent from the disclosure contained herein. The above-described embodiments, objectives, and configurations are neither complete nor exhaustive. The Summary is neither intended nor should it be construed as being representative of the full extent and scope of the present disclosure. Moreover, references made herein to “the present disclosure,” or aspects thereof should be understood to mean certain embodiments of the present disclosure and should not necessarily be construed as limiting all embodiments to a particular description. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

It is to be appreciated that any embodiment, feature, or aspect described herein can be claimed in combination with any other embodiment(s), feature(s), or aspect(s) as described herein, regardless of whether the features or aspects come from the same described embodiment. For example, any one or more aspects described herein can be combined with any other one or more aspects described herein. In addition, any one or more features described herein can be combined with any other one or more features described herein. Further, any one or more embodiments described herein can be combined with any other one or more embodiments described herein.

### BRIEF DESCRIPTION OF THE DRAWINGS

FIG. 1A is a graph depicting the transient H flux (in a.u.) under H₂ plasma exposure comparing fresh Pd foils and after He plasma treatments at 75° C. for various lengths of time.

FIG. 1B is a graph depicting the transient H flux (in a.u.) under H₂ plasma exposure comparing fresh Pd foils and after He plasma treatments at 200° C. for various lengths of time.

FIG. 2A is a graph comparing the initial flux attenuation (in a.u.) after He plasma exposure at 75° C. among Pd foils, PdAg foils, and PdCu foils for various lengths of time.

FIG. 2B is a graph comparing the initial flux attenuation (in a.u.) after He plasma exposure at 200° C. among Pd foils, PdAg foils, and PdCu foils for various lengths of time.

FIG. 3 is a graph comparing the temperature range for “fuzz” formation among candidate metal foil pump (“MFP”) materials.

FIG. 4 is a graph of permeate flux and feed pressure as functions of time in a MFP system according to the present disclosure.

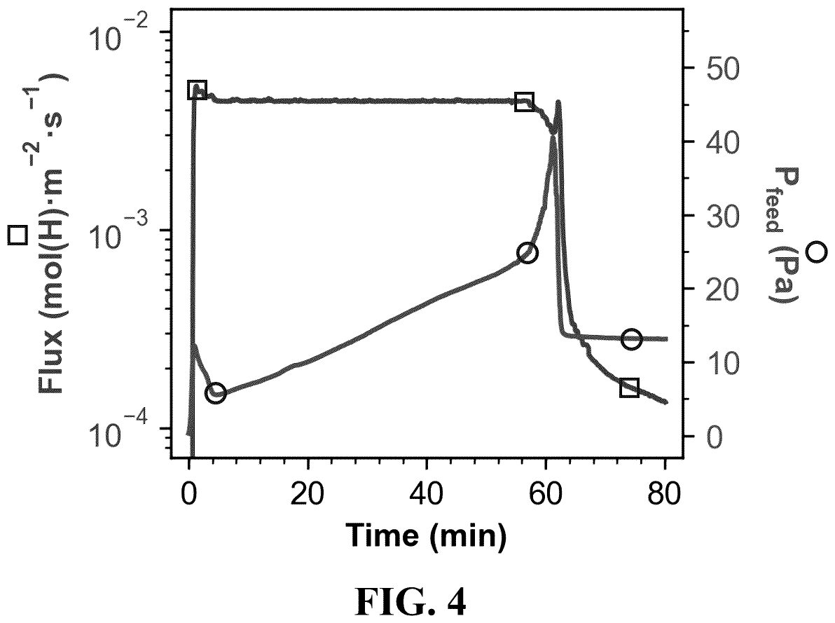

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

To comply with applicable written description and enablement requirements, the following documents are incorporated herein by reference in their entireties:

European Patent 3,061,098, issued 27 Dec. 2017 to Day et al.

Chao Li et al., “Direct internal recycling fractions approaching unity,” 209 Fusion Engineering and Design 114705 (December 2024).

Chao Li et al., “The impact of helium on plasma-driven hydrogen permeation and implications for direct internal recycling in the fusion fuel cycle,” 65 (1) Nuclear Fusion 016039 (January 2025).

### Metal Foil Pump System Device (“MFP System”)

The methods and systems of the present disclosure allow for up to 100% direct internal recycling (DIR) of hydrogen isotopes from plasma exhaust, thus reducing operational costs of a fusion reactor. Particularly, the methods and systems of the present disclosure allow for up to 100% DIR by enabling separation of hydrogen isotopes from the plasma exhaust using metal foil pumps (MFPs) containing materials that are effective at low temperatures (approximately 25° C. to approximately 200° C.). Use of the methods and systems of the present disclosure may also provide further advantages and benefits, such as a reduction in safety hazards due at least to a reduction in tritium (T) inventory on site.

The goal of the present disclosure is to achieve the ideal DIR fraction, which is estimated at approximately 80% due to the need for tritium in certain processes in the tritium plant, although in some embodiments, up to 100% DIR may be achieved. This 80% recovery of DT from the exhaust may lead to an average helium content of 2% to 25%, depending on the reaction, or “burn,” fraction, while the concentration polarization may further enrich the helium density at the metal foil surface relative to the bulk of the foil.

The present disclosure provides a system that is capable of continuous processing of plasma exhaust to achieve 100% DIR for at least about three days, at least about four days, at least about five days, at least about six days, at least about seven days, at least about eight days, at least about nine days, at least about ten days, at least about eleven days, at least about twelve days, at least about thirteen days, at least about fourteen days, at least about fifteen days, at least about sixteen days, at least about seventeen days, at least about eighteen days, at least about nineteen days, at least about twenty days, at least about 21 days, at least about 22 days, at least about 23 days, at least about 24 days, at least about 25 days, at least about 26 days, at least about 27 days, at least about 28 days, at least about 29 days, at least about 30 days, at least about two months, at least about three months, at least about four months, at least about five months, at least about six months, at least about seven months, at least about eight months, at least about nine months, at least about ten months, at least about eleven months, or at least about one year.

The systems and methods of the present disclosure represent an important and significant advance over the current state of the art in that they enable continuous DIR of up to 100% of hydrogen isotopes from plasma exhaust by utilizing MFPs operated at low temperatures (approximately 25° C. to approximately 200° C.) to ensure that helium does not attenuate MFP performance.

Another advantage of the MFP systems of the present disclosure compared to previous MFPs utilized in DIR is that the materials are not susceptible to hydrogen embrittlement at lower temperatures (i.e., the deterioration of structural properties of solid metals due to the presence of hydrogen).

### Process Parameters

Several important factors must be considered in the deployment of MFPs for DIR of plasma exhaust, including materials, operating temperatures, and acceptable helium concentrations.

Plasma exhaust refers to the gas that is removed from the reaction chamber (i.e., torus) of a fusion reactor. The plasma exhaust consists mainly of unreacted fuel, but also contains impurities such as helium, also referred to as helium ash, as well as varying amounts of at least one of hydrocarbons, ammonia, hydrogen gas (H₂), and nitrogen.

While the plasma exhaust is expected to contain approximately 1-5% helium, in DIR the source gas would be enriched in helium as hydrogen isotopes are extracted. Helium's impact on hydrogen plasma permeation, particularly at helium levels of greater than 20%, is poorly understood. This disclosure explores the impact of helium addition over the full range (0 to 100%) on hydrogen plasma-driven permeation at low temperatures (approximately 25° C.-approximately 200° C.). While high helium levels would not typically be experienced in practical DIR (e.g., 80% DIR on a 1% exhaust would enrich helium to only about 5%), long-term MFP degradation may occur under lower helium levels. Additionally, while the average helium fraction is expected to be relatively low in DIR, there will be spatial variations within the system as DT isotopes are extracted; specifically, helium will be enriched at the surface of the metal foil due to concentration polarization. Moreover, the current approaches for removing hydrogen isotopes from high levels of helium include energy intensive cryogenic separations, gettering beds, and conventional pressure-driven membrane separations. These processes become increasingly inefficient as the helium fraction is increased, and for certain applications, MFPs may offer a competitive alternative.

The potential of low-energy He ions to alter metals has been observed and creates nanoscale arborescent shaped features on tungsten exposed to low-energy He′, albeit at much higher fluence wherein the fluence is the number of particles that pass through a unit area, integrated over time. Subsequently this phenomenon, colloquially known as “fuzz” formation by low-energy (10-100 eV) He irradiation, has been documented. The resulting morphological changes have a temperature dependence that appears to scale with the melting temperature of the metal (Tₘ). At high temperatures (T>0.54 Tₘ), large (approximately micrometer scale) pinholes are generally observed. Fuzz, a film with nanoscale porosity, is formed at intermediate temperatures (0.27 Tₘ<T<0.54Tₘ), and at lower temperatures (T<0.27 Tₘ.), helium nanobubbles have been observed within materials. These morphological changes associated with low-energy He irradiation are also dependent on flux and have only been observed at high fluence (>10²⁰ cm⁻²).

Traditionally, MFPs are made from Group 5 elements (vanadium, niobium, and/or tantalum) that exhibit the body-centered cubic (BCC) crystal structure and have high bulk permeability. However, these MFPs must be operated at high temperatures (approximately 600° C. to approximately 1000° C.) to overcome surface barriers to both absorption of superthermal hydrogen upstream and hydrogen desorption downstream. However, this brings additional challenges associated with thermal expansion mismatches, sealing, and long-term material integrity. Recent studies have shown that negligible plasma permeation is observed in vanadium foils at low temperatures (approximately 25° C.-approximately 200° C.). In addition, BCC metals are susceptible to hydrogen embrittlement at lower temperatures.

Given the present disclosure and the experiments conducted related thereto, the application of thin (˜100 nm) layers of at least one of the presently contemplated materials may improve surface kinetic limitations and elevate performance of the Group 5 elements or symmetric composites to a level commensurate with the experiments conducted herein.

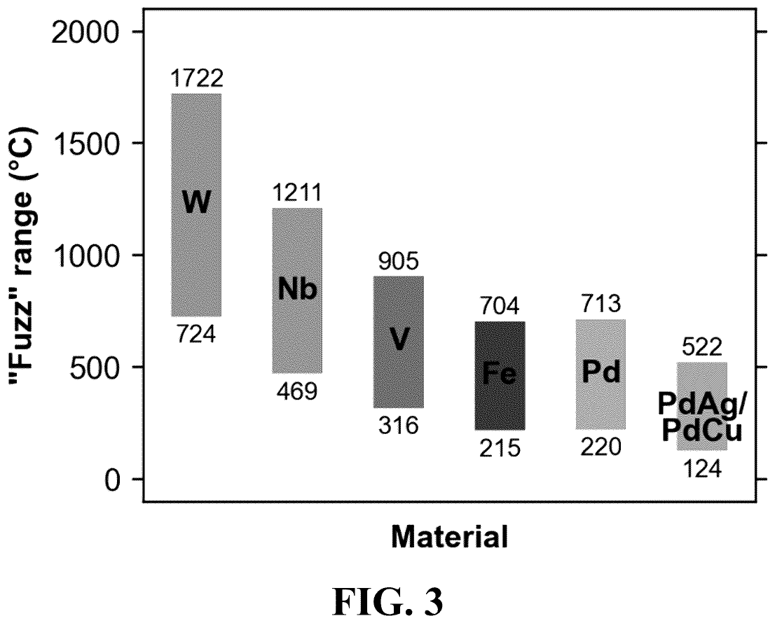

Further, as discussed above, absorption of low-energy He⁺ is temperature dependent and the formation of fuzz occurs in a window (0.27 Tₘ<T<0.54 Tₘ) after sufficient He⁺ fluence. As shown in FIG. 3, the desired operating temperature of niobium and vanadium MFPs falls directly within this window, meaning they are extremely susceptible to He uptake and its deleterious consequences.

When MFPs are exposed to helium under high temperatures (e.g., greater than 200° C., and especially greater than 600° C.), the foils absorb helium, attenuating future performance of the foils by inhibiting absorption of superthermal hydrogen. The degree of attenuation scales with the level of helium retention. However, when MFPs according to the present disclosure are made from embrittlement-tolerant materials that are effective for DIR at lower operating temperatures, the extent of attenuation is greatly diminished.

In some embodiments of the present disclosure, therefore, an MFP comprises embrittlement-tolerant materials such as palladium (Pd), palladium alloys (e.g., palladium-copper (PdCu) alloys, palladium-silver (PdAg) alloys, etc.), and/or iron (Fe).

In some embodiments, the MFP is made substantially or entirely from palladium (Pd). In some embodiments, the MFP is made substantially or entirely from a palladium-silver (PdAg) alloy (e.g., an approximately 75 wt % palladium/25 wt % silver alloy). In some embodiments, the MFP is made substantially or entirely from a palladium-copper (PdCu) alloy (e.g., an approximately 60 wt % palladium/40 wt % copper alloy).

The materials may be most effective at temperatures ranging from about 25° C. to about 200° C. (or any subrange thereof).

When MFPs of the present disclosure are exposed to helium at lower temperatures (e.g., no more than about 200° C.), performance is less attenuated, and the MFPs are able to recover to full performance after a recovery period. Additionally, SEM inspection of the palladium (Pd) and palladium alloy foils before and after 1-hour pure helium plasma exposure revealed no discernible change to morphology. The MFPs can also be returned to their original performance by utilizing an ionic argon (Art) sputter clean. Further, as it relates to low temperature operations, it has been observed that hydrogen desorption constant increases with temperature, while bulk solubility decreases and flux increases with reductions in temperature.

### Plasma

The direct internal recycling of plasma exhaust can be used in conjunction with numerous types of plasma. In some embodiments, the plasma is microwave plasma. In some embodiments, the plasma is inductively coupled plasma.

### Metal Foil Pump (MFP) Implementation

The placement of the MFP is an important consideration. Placing the MFP upstream near the divertor region exposes it to superthermal hydrogen isotopes, but also subjects it to potential degradation from energetic neutrons, ion bombardment, and/or extreme temperatures. Additionally, placing the MFP within the divertor region may subject it to high energy (10-1000 keV) and/or high fluence (10¹⁶-10¹⁷ cm⁻²) helium ions that may create extensive defects (such as helium bubbles), which may trap hydrogen isotopes and correlate to decreases in both pressure-driven and plasma-driven hydrogen permeation.

Alternatively, positioning the MFP farther downstream reduces exposure to these potential sources of degradation, as the low-energy helium ions do not interact with the MFP as aggressively, but this positioning necessitates a secondary source for superthermal hydrogen generation. Morphological changes associated with low-energy helium irradiation are also dependent on flux and have only been observed at high fluence (>10²⁰ cm⁻²).

In addition, recognizing both the need for continuous processing and periodic regeneration of MFPs due to contamination from helium and other impurities in the plasma exhaust, some embodiments of the present disclosure make use of a bank of MFPs that alternate between use and regeneration to provide stable, continuous processing of the plasma exhaust.

In some embodiments, one MFP is used. In some embodiments, two MFPs are used. In some embodiments, three or more MFPs are used.

The inventive concepts disclosed herein are further described by way of the following non-limiting examples.

### EXAMPLES

### Example 1: Impact of Helium on Metal Foil Pump (“MFP”) Performance

Free-standing, cold-rolled palladium (99.9%, 25 μm, Alfa Aesar), 75 wt % palladium/25 wt % silver alloy (25 μm, Wilkinson Company, Post Falls, ID, USA), and 60 wt % palladium/40 wt % copper alloy (25 μm, ATI Specialty Alloys and Components, Albany, OR, USA) foils were used. For brevity, the alloys are hereinafter denoted as PdAg and PdCu, respectively. PdCu was transformed into the desired body-centered cubic (BCC) crystal structure through a heat treatment process conducted under helium atmosphere at 400° C. for 2 hours, followed by passive cooling to room temperature. Both sides of the metal foils were cleaned symmetrically in an AJA International sputtering chamber that was initially pumped to ultra-high vacuum conditions. Argon plasma cleaning was implemented to eliminate surface impurities before conducting permeation tests. Foils were clamped to a water-cooled susceptor, to which was applied a 50 W radio frequency (RF) bias for 30 minutes, operating at a pressure of 0.67 Pa in an argon atmosphere and a direct current bias of approximately 310 V.

Membranes with an effective permeation area of 0.93 cm² were securely sealed within a Swagelok VCR fitting module, dividing the system into a feed side (upstream) chamber and a permeate side (downstream) chamber. The membrane temperature was actively regulated by a proportional-integral-derivative (PID) controller (Series 96, Watlow) connected to a type K thermocouple and a resistive heating wire. Evacuation of the feed side chamber was achieved using a turbomolecular pump with a nominal pumping speed of 48 L/s for hydrogen, while an RF power source (13.56 MHz) coupled to a water-cooled coil outside the quartz tube generated an inductively coupled plasma. Ultra-high purity grade H₂ and He were delivered through electronic mass flow controllers (MFCs). The upstream pressure (P₁) was measured using an MKS capacitance manometer (0.01 to 100 Pa). Throughout all tests, plasma conditions were held constant at 100 W of RF power where P₁=10 Pa. The plasma was characterized by optical emission spectroscopy (OES). A fiber optic cable, fixed on the viewport orthogonal to the membrane and aligned ˜1 mm in front of the membrane, collected and transmitted the plasma emission to an optical emission spectrometer (Spectro Vis Plus, Vernier). A notable color change, from pink to blue, was observed as the hydrogen concentration changed from 100% to 0%, which was related to the main emission peak shifting between pure hydrogen and pure helium.

MFPs were exposed to pure helium plasma exposure treatments ranging from 0 to 100% hydrogen in 20% increments at 75° C. and at 200° C. In these treatments, sputter-cleaned foils were first exposed to pure hydrogen plasma to establish the ideal hydrogen flux. Then the plasma was extinguished, the gas was switched, and the foils were exposed to pure helium plasma for designated times. After helium plasma exposure, the gas composition was returned to pure hydrogen, and the plasma permeation was measured. Helium depth profiles and surface morphology of the foils were measured, at least in part, using time-of-flight secondary-ion-mass spectrometry and/or field emission scanning electron microscopy, but the use of additional or alternative measuring apparatuses is contemplated herein. While there is some uncertainty as to absolute depth, due at least in part to slow sputter rates employed and the measurement of resulting crater depth, it could still be determined that helium is limited to the near surface region, suggesting that its role is to inhibit absorption of superthermal hydrogen and thereby reduce the atomic hydrogen concentration within the foils. However, it may have no impact on bulk diffusivity or permeate desorption, as all foils showcased the ability to return to original performance with an argon-based sputter clean (which may be replaceable with another inert fluid and/or method of cleaning). Based on these findings, the present inventors conclude that it takes very little helium absorption to significantly inhibit hydrogen superpermeation under conditions utilized in at least some embodiments of the presently disclosed experimentation.

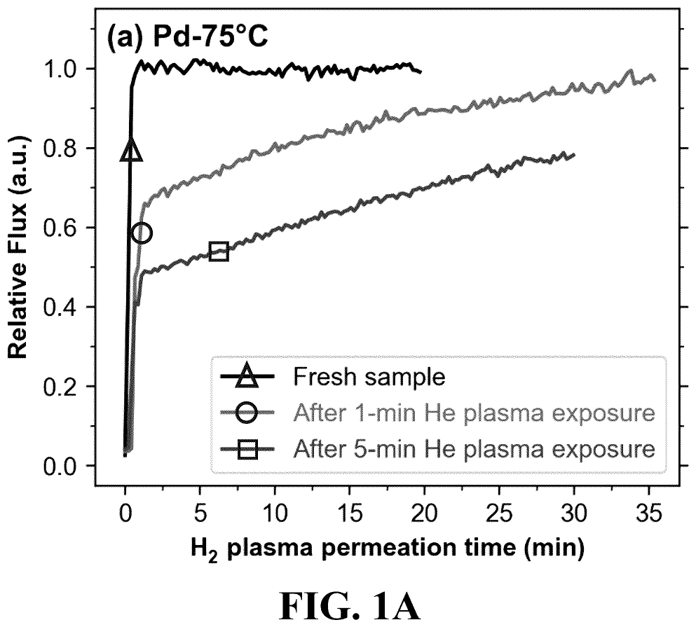

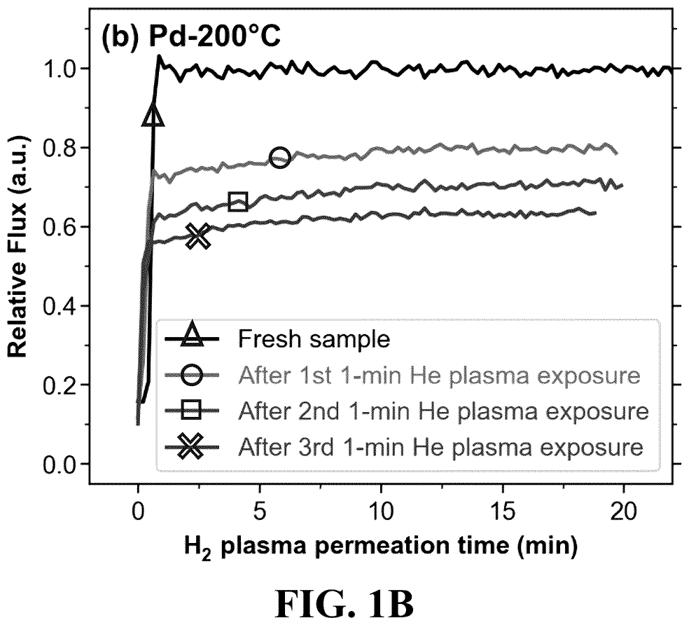

FIGS. 1A and 1B compare the transient hydrogen permeation upon plasma ignition for a clean palladium (Pd) foil and after different levels of helium plasma exposure at 75° C. (FIG. 1A) and 200° C. (FIG. 1B). In FIGS. 1A and 1B, all data are normalized to the steady state hydrogen flux obtained with a sputter-cleaned foil tested in a pure hydrogen (H₂) environment.

At 75° C., after just 1 minute of helium plasma exposure, the initial hydrogen flux was reduced to 70% of the original value, and it further decreased to 50% of the original value after a 5-minute helium plasma exposure (FIG. 1A). Under pure hydrogen plasma, these foils eventually returned to their original performance over time scales on the order of an hour.

At 200° C., the degree of initial attenuation was similar, but foils did not fully recover under hydrogen plasma. As shown in FIG. 1B, the flux was reduced to ˜30% of the original value after 1 minute of helium plasma exposure at 200° C. However, in this case, the recovery was limited. Following approximately 20 minutes of hydrogen plasma permeation, the same foil underwent another 1-minute exposure to helium plasma, resulting in further attenuation of the flux with limited recovery. This trend persisted through a third 1-minute treatment.

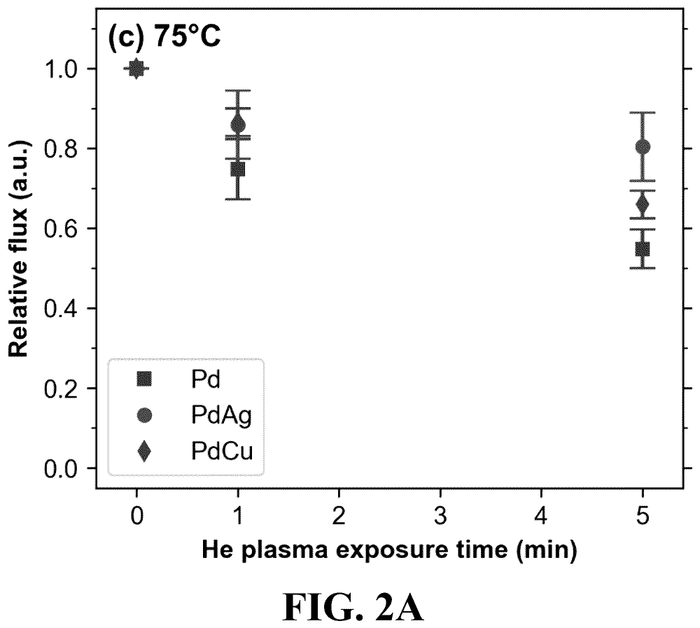

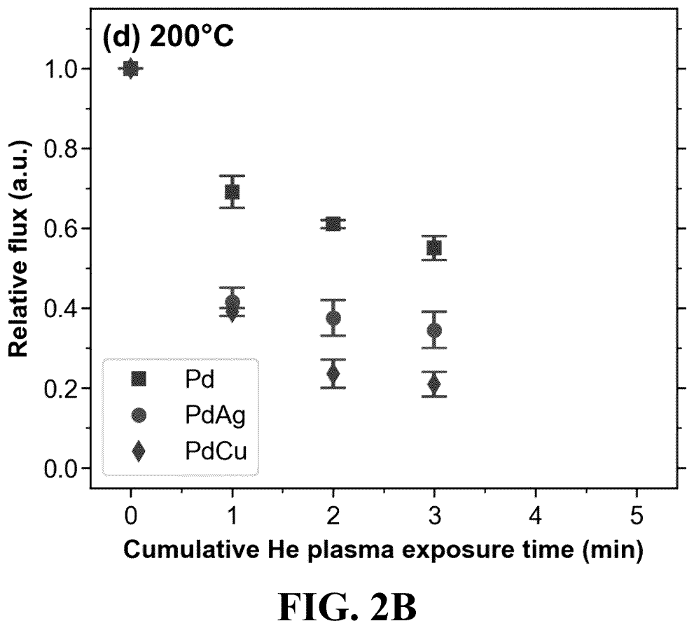

These experiments were replicated on PdAg and PdCu foils, and similar behavior was observed. All foils experienced attenuation that increased with helium plasma exposure. Foils at 75° C. fully recovered under hydrogen plasma exposure, while foils treated at 200° C. did not. Further, it was found that in all metals, the flux at 75° C. was greater than at 200° C., reflecting the finding that absorption of superthermal hydrogen is the rate-limiting step. Additionally, it was seen that, when normalized, the flux scaled approximately with the hydrogen, which is consistent with permeation being an absorption limited process, where the concentration of hydrogen in the tested foils was proportional to the partial pressure of hydrogen atoms in the plasma. FIGS. 2A and 2B compare the initial attenuation among the three foils as a function of helium plasma exposure at 75° C. and 200° C., respectively. For all three materials, operating at higher temperatures renders them more susceptible to the negative impacts of helium plasma exposure on their superpermeability. The two alloys PdAg and PdCu displayed very similar behavior while the pure Pd experienced greater flux attenuation compared to the two alloys at 75° C., but interestingly exhibited increased resilience at 200° C., which may be strong evidence that the degree of attenuation scales with the level of helium retention. However, in at least one experiment conducted relative to the present disclosure, the PdCu alloy showcased superior performance in the order of absolute hydrogen flux, relative to the remaining foils, which may be attributable to its superior hydrogen desorption kinetics.

### Example 2: 100% Direct Internal Recycling (DIR)

This experiment was conducted to show that up to 100% DIR could be achieved through use of the MFP system of the present disclosure. MFPs comprising PdCu were exposed to a surrogate exhaust comprising 1% He/H₂ at ˜1 sccm. The chamber was evacuated and the feed was introduced at t=0 minutes. The feed pressure increased and, once it reached ˜15 Pa after ˜2 minutes, the plasma was ignited, resulting in the step increase in permeation. Permeation continued at a fairly constant rate for ˜55 minutes. The feed pressure initially dropped upon plasma ignition, as the rate of permeation was greater than the feed flow. The feed pressure hit a minimum at t=˜ 5 minutes and slowly increased as the feed chamber was enriched in He. The pressure increased more sharply at t=55 minutes, which led to a reduction in flux. At approximately t=60 minutes the feed was shut off, which led to a rapid drop and saturation in feed pressure. This is due to the removal of the remaining H₂, leaving a He plasma indicating 100% DIR was achieved.

The concepts illustratively disclosed herein suitably may be practiced in the absence of any element which is not specifically disclosed herein. It is apparent to those skilled in the art, however, that many changes, variations, modifications, other uses, and applications of the disclosure are possible, and changes, variations, modifications, other uses, and applications which do not depart from the spirit and scope of the disclosure are deemed to be covered by the disclosure.

The foregoing discussion has been presented for purposes of illustration and description. The foregoing is not intended to limit the disclosure to the form or forms disclosed herein. In the foregoing Detailed Description, for example, various features are grouped together in one or more embodiments for the purpose of streamlining the disclosure. The features of the embodiments may be combined in alternate embodiments other than those discussed above. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment.

Moreover, though the present disclosure has included description of one or more embodiments and certain variations and modifications, other variations, combinations, and modifications are within the scope of the disclosure, e.g., as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

1. A system for the continuous processing of plasma exhaust of a fusion reactor, comprising:
one or more metal foil pumps,
wherein the one or more metal foil pumps are configured to operate at a temperature of approximately 25° C. to approximately 200° C.

2. The system of claim 1, wherein the one or more metal foil pumps comprise a material selected from the group consisting of palladium, a palladium-copper alloy, a palladium-silver alloy, iron, and combinations thereof.

3. The system of claim 2, wherein the one or more metal foil pumps comprise an approximately 60 wt % palladium/40 wt % copper alloy.

4. The system of claim 2, wherein the one or more metal foil pumps comprise an approximately 75 wt % palladium/25 wt % silver alloy.

5. The system of claim 1, wherein the one or more metal foil pumps are configured to achieve a direct internal recycling (DIR) fraction of at least about 60%.

6. The system of claim 5, wherein the one or more metal foil pumps are configured to achieve a DIR fraction of at least about 80%.

7. The system of claim 6, wherein the one or more metal foil pumps are configured to achieve a DIR fraction of about 100%.

8. The system of claim 1, wherein the one or more metal foil pumps are configured to operate with an applied bias of about −5 V to about −50 V.

9. A system for direct internal recycling of deuterium and tritium, comprising:
a feed region, in fluid communication with an outlet of a torus of a fusion reactor and configured to receive plasma exhaust from the torus;
a permeate region, in fluid communication with an inlet of a fueling system of the fusion reactor and configured to discharge treated plasma exhaust into the fueling system; and
one or more metal foil pumps, configured to selectively allow hydrogen isotopes in the plasma exhaust in the feed region to permeate therethrough into the permeate region, and to selectively absorb or repel helium in the plasma exhaust such that the helium is retained in the feed region, thereby forming the treated plasma exhaust in the permeate region, at an operating temperature of about 25° C. to about 200° C.

10. The system of claim 9, wherein the one or more metal foil pumps comprise a material selected from the group consisting of palladium, a palladium-copper alloy, a palladium-silver alloy, iron, and combinations thereof.

11. The system of claim 10, wherein the one or more metal foil pumps comprise an approximately 60 wt % palladium/40 wt % copper alloy.

12. The system of claim 10, wherein the one or more metal foil pumps comprise an approximately 75 wt % palladium/25 wt % silver alloy.

13. The system of claim 9, wherein the one or more metal foil pumps are configured to achieve a direct internal recycling (DIR) fraction of at least about 60%.

14. The system of claim 13, wherein the one or more metal foil pumps are configured to achieve a DIR fraction of at least about 80%.

15. The system of claim 14, wherein the one or more metal foil pumps are configured to achieve a DIR fraction of about 100%.

16. The system of claim 9, wherein the one or more metal foil pumps operate at a bias of about −5 V to about −50 V.

17. A method for direct internal recycling (DIR) of deuterium and tritium in a fusion power plant, comprising:
introducing plasma exhaust from a torus of a fusion reactor into a feed region of a DIR system, the plasma exhaust comprising helium and deuterium and/or tritium;
causing the plasma exhaust in the feed region of the DIR system to contact one or more metal foil pumps of the DIR system, whereby the metal foil pumps (i) selectively allow at least a portion of the deuterium and/or tritium in the plasma exhaust in the feed region to permeate therethrough into a permeate region of the DIR system, thereby forming a treated plasma exhaust in the permeate region, and (ii) selectively absorb or repel at least a portion of the helium in the plasma exhaust in the feed region; and
discharging the treated plasma exhaust from the permeate region of the DIR system into a fueling system of the fusion power plant,
wherein an operating temperature in the DIR system is about 25° C. to about 200° C.

18. The method of claim 17, wherein the one or more metal foil pumps comprise a material selected from the group consisting of palladium, a palladium-copper alloy, a palladium-silver alloy, iron, and combinations thereof.

19. The method of claim 18, wherein the one or more metal foil pumps comprise an approximately 60 wt % palladium/40 wt % copper alloy, an approximately 75 wt % palladium/25 wt % silver alloy, or a combination thereof.

20. The method of claim 17, characterized by a direct internal recycling (DIR) fraction of at least about 60%.

21. The method of claim 20, wherein the DIR fraction is at least about 80%.

22. The method of claim 21, wherein the DIR fraction is about 100%.

23. The method of claim 17, wherein, during at least a portion of the causing step, a bias of about −5 V to about −50 V is applied to the metal foil pumps.
